(19) United States
(12) Patent Application Publication
(10) Pub. No.: US 2020/0380560 A1
(43) Pub. Date: Dec. 3, 2020

(54) AUTOMATED DIGITAL ADVERTISING USING BEHAVIORAL INTELLIGENCE

(71) Applicant: NCR Corporation, Atlanta, GA (US)

(72) Inventor: Robert David Saker, Sandy Springs, GA (US)

(21) Appl. No.: 16/426,908

(22) Filed: May 30, 2019

(51) Int. Cl. G06Q 30/02

(52) U.S. Cl. CPC G06Q 30/0254; G06Q 30/0246; G06Q 30/0277; G06Q 30/0249; G06Q 30/0261

(57) ABSTRACT

Disclosed are systems and methods for deploying a targeted advertisement. The systems and methods may include identifying a time period of expected decreased traffic. The targeted advertisement may be generated based on constraints set by a user. Targeted advertisement may be deployed during a predetermined time period prior to the time period of expected decreased traffic.

### SUMMARY

Disclosed are systems and methods for deploying a targeted advertisement. The systems and methods may include identifying a time period of expected decreased traffic. The targeted advertisement may be generated based on constraints set by a user. Targeted advertisement may be deployed during a predetermined time period prior to the time period of expected decreased traffic.

### BRIEF DESCRIPTION OF THE FIGURES

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 shows an example user interface consistent with embodiments disclosed herein.

FIG. 2 shows an example schematic of a computing device consistent with embodiments disclosed herein.

FIG. 3 shows an example method consistent with this disclosure.

Corresponding reference characters indicate corresponding parts throughout the several views. The exemplifications set out herein illustrate exemplary embodiments of the invention, and such exemplifications are not to be construed as limiting the scope of the invention any manner.

### DETAILED DESCRIPTION

The following detailed description refers to the accompanying drawings. Wherever possible, the same reference numbers are used in the drawings and the following description to refer to the same or similar elements. While embodiments and examples are described, modifications, adaptations, and other implementations are possible. For example, substitutions, additions, or modifications may be made to the elements and stages illustrated in the drawings, and the systems and methods described herein may be modified by substituting, reordering, or adding stages to the disclosed methods or elements to the discloses systems. Accordingly, the following detailed description does not limit this disclosure. Instead, the proper scope of any invention disclosed herein is defined by the appended claims.

Disclosed herein are systems and methods that enable users such as small business owners/operators to create highly targeted advertisements on various platforms such as Google, Facebook, etc. with a wizard-like approach. The users may use the systems and methods disclosed herein to create and target advertisements without the need to use sophisticated advertisement agencies. This is made possible by using data, such as behavioral intelligence data, to automatically identify micro-segments of individuals that are the most likely to partake in an offer. Artificial intelligence may also be used to optimize advertisement channel mix and optimize the AI itself for future advertisement campaign cycles.

The systems and methods disclosed herein may allow small and mid-sized businesses to grow their businesses through advertising. The systems and methods may allow for digital channels to be used to perform advertising without the need for the sophistication of large operators in building and placing advertisements. As a result, users' advertisement dollars are less productive than larger players.

As disclosed herein, an application, such as a mobile application, may use a daily and/or hourly level predictive forecast to identify gaps in revenue. The application may alert users when revenue is expected to be soft. The users may then create targeted advertisements to draw customers during times when revenue may be down.

As disclosed herein, building a highly sophisticated advertisement program has been simplified to a few clicks and a slider. The AI logic does the work. As disclosed herein, a slider may allow users to select a budget (i.e., how much they want to spend) for the advertisement program. Using the behavioral intelligence data and the advertisement created, the application may show a predicted return on investment (ROI) that may be generate from the money spent on the targeted advertisement. Once the advertisement is created, the systems disclosed herein may select a group, such as a hyper-segment of consumers, based on the location and level of spending on the advertisement.

The advertisement may be built by a user or selected from existing advertisements. The user may select the channel they want to run the advertisement on. For example, the user can select to run the advertisement on Facebook, but not Google.

Integration to platforms such as Facebook, Google, or others may be automated. The systems disclosed herein may use reinforced neural net models to identify the optimal mix of advertisement spend by channel for each advertisement based on a response, pricing efficiency, and other factors. For example, the systems may use neural networks to identify which advertisements, channels, messages, audience segments, etc. to generate the best results and use this information to improve its accuracy in future advertisement cycles.

The behavioral intelligence data may be used to ensure the advertisements are run only against the segments that are likely to buy at that store. For example, using data related to how people spend their money and past reactions to advertisements, consumers can be selected as part of a group to which the advertisements should be sent. This use of behavioral intelligence data may help to minimize or eliminate advertisement dollars that would otherwise be spent sending advertisements to uninterested consumers or consumers less likely to be swayed by a targeted advertisement.

The systems and methods disclosed herein improve the marketing ROI for customers by removing spending on advertising to audience segments that less likely to purchase the product or service, and by automating the selection of the channel (e.g. Facebook, Google, Closecomms, etc.) for running the advertisements.

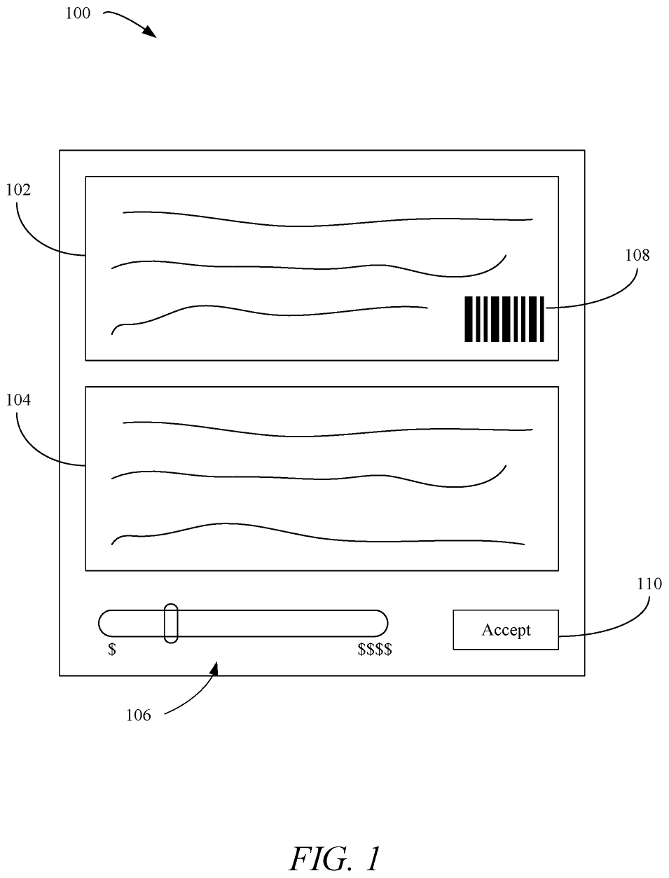

Turning now to the figures, FIG. 1 shows an example user interface 100 consistent with embodiments disclosed herein. User interface 100 may include an advertisement 102, consumer data 104, and a slider 106. Advertisement 102 may include a barcode 108 that a user may use to allow a consumer to utilize the coupon. For example, when the consumer receives advertisement 102, the user can scan barcode 108 once presented by the consumer.

User interface 100 may be displayed on a mobile device of a user or on a display of a computer, such as a desktop or other stationary computer. For example, user interface 100 may be part of an ap on a mobile device such as a phone, tablet, etc. User interface 100 may also be displayed via a web browser on a desktop computer.

During use, consumer data 104 may be displayed via user interface 100. Consumer data 104 may include, but is not limited to, time periods where the user may expect decreased traffic. For example, as disclosed herein, data of past customer visits to the user's business. Using the data, which may be displayed in graphical form, the user may be able to see times where customer traffic may be expected to drop. The expectation of a drop in customer traffic may also be based on other data. For example, the systems disclosed herein may access remote systems that may provide data regarding concerts, sporting events, or other events that may be happening during given times and on given days. As a result, the events may have an impact on the user's business traffic. The data may also indicate when there may be an increase in customers near the user's business. For example, a concert near the user's business may result in an increase in potential customers being in a vicinity of the user's business. Consumer data 104 may also include information about average spend by consumers and other demographics such as age, income, etc.

Using the consumer data 104 the user may be able to design advertisement 102. The user can use user interface 100 to select elements for advertisement 102. The user can also select advertisements previously created by the user or from a catalog included with the ap. Part of generating advertisement 102 may include generating an incentive to be included in advertisement 102. The incentive may specific a discount for an item, identify a free item, etc.

Slider 106 may allow the user to select a budget for the advertisement campaign. For example, if the expected decrease in traffic is large, the user may want to spend more money to target a larger audience to try and minimize the decrease in traffic. The slider may include numerical displays of dollar amounts.

As part of setting the budget for the advertisement campaign, slider 106 may also display an expected ROI for the budget amount. For example, consumer data 104 may be used in conjunction with the budget to formulate an expected ROI for the advertisement campaign. For instance, with an increased budget, more consumers may receive the advertisement. Based on an expected percentage of consumers that may utilize the advertisement, the expected ROI can be calculated and displayed to the user. Using the expected ROI the user can determine if increased spending on the advertisement campaign is warranted given an expected ROI.

Once the user has selected a budget and advertisement 102, the user can approve/send the advertisement using an approval button 110. Upon approving advertisement 102, advertisement 102 may be sent to a remote computer where it may be transmitted to potential consumers. The potential consumers may be located within a predetermined distance of a location. For example, advertisement 102 may be sent to customer's with X miles of the user's business or customer's that are expected to be within X miles of the user's business during the time of expected decreased traffic.

As disclosed herein, consumer data 104 may be update periodically. The periodic updates may occur every hour, ever 6 hours, ever day, every other day, once a week, etc. The updated consumer data 104 may include updated traffic data that indicates traffic at the user's business. This data may be supplemented by data from the user's point of sale system, data from third party systems that include customer spend data a nearby locations, etc.

Using the updated consumer data 104, the user can increase or decrease the incentive provided in advertisement 102. For example, if traffic at the user's business does not increase as expected, the user can increase the value of the incentive in an attempt to draw more customers. If the traffic at the user's business is greater than expected, the user can decrease the value of the incentive to increase the ROI of the advertisement campaign in the future. This iterative process of updating consumer data 104, the budget via slider 106, etc. may allow the user to continually adjust the advertisement campaign to maximize his or her ROI for advertising dollars spent.

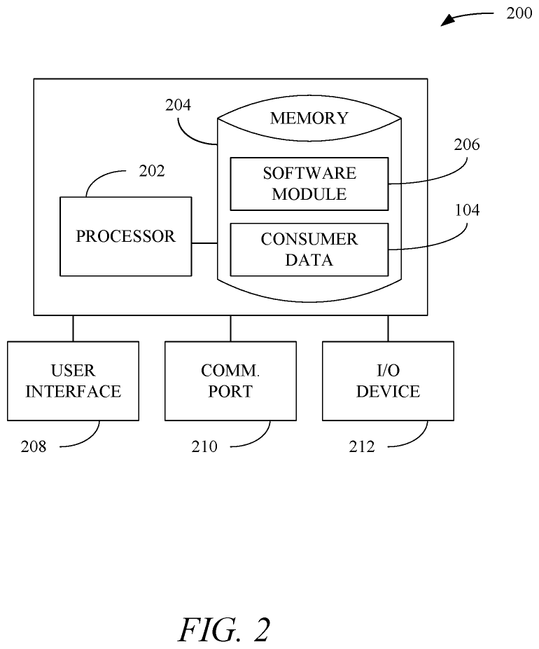

FIG. 2 shows an example schematic of a computing device 200 consistent with embodiments disclosed herein. Computing device 200 may be a remote computer, such as a server, that may be used to deploy targeted advertisements, such as advertisement 102, to consumers. Computing device 200 may also be a mobile device that may be used by a user to create the targeted advertisement, which may be sent to the remote computer to be distributed. The targeted advertisement may also be sent directly from a mobile device of a user to customer's via email, text message, or other methods using contact information the user may have for customers.

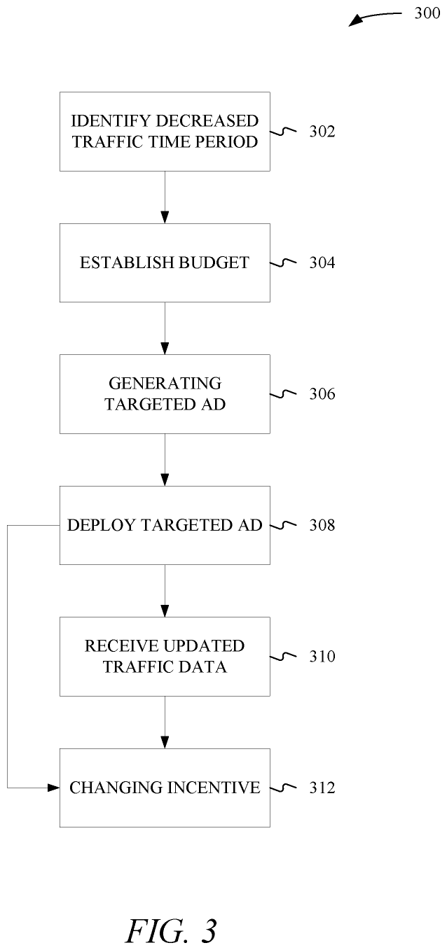

Computing device 200 may include a processor 202 and a memory 204. Memory 204 may include a software module 204 and consumer data 104. While executing on processor 202, software module 206 may perform processes for deploying a targeted advertisement, including, for example, one or more stages included in a method 300 described below with respect to FIG. 3.

Computing device 200 include a user interface 208. User interface 208 may allow a user to display user interface 100. User interface 208 may allow users, such as business owners, consumers, etc. to interact with computing device 200. User interface 208 may include a keypad, a display (touchscreen or otherwise), etc.

Computing device 200 may also include a communications port 210. Communications port 210 may allow computing device 200 to communicate with various information sources, such as, but not limited to, third parties that may supply consumer data 104, point of sale systems of a user, mobile devices of consumers, etc. Communications port 210 may be wired or wireless. Non-limiting examples of communications port 210 include, Ethernet cards (wireless or wired), Bluetooth® transmitters and receivers, near-field communications modules, serial port interfaces, cellular interfaces, etc.

Computing device 200 may also include an input/output (I/O) device 212. I/O device 212 may allow computing device 200 to receive and output information. Non-limiting examples of I/O device 212 include, a camera (still or video), a printer, a scanner, biometric readers, etc. For example, I/O device 212 may include a camera or scanner that can be used to scan barcodes on a mobile device. I/O device 212 may also include a printer that can be used to print customer receipts, etc.

FIG. 3 shows an example method 300 consistent with embodiments disclosed herein. Method 300 may include identifying a time period of expected decreased traffic (302). For example, as disclosed herein, a concert, sporting event, or other factors may draw customers away from a business, such as a restaurant, store, etc. While an event is used as an example, there does not necessarily need to be an event to cause decreased traffic. Decreased traffic may be caused by competing businesses opening nearby, change in demographics of customers in the area, general slowness experienced throughout a day, etc.

Method 300 may also include a user establishing a budget (304) for an advertisement campaign. The budget may be established using slider 106 as disclosed above. Establishing the budget may also include calculating an expected ROI for the given budgets.

Method 300 may also include generating the targeted advertisement (306). As disclosed herein, generating the targeted advertisement may include a user designing the advertisement or selecting a previously used or generated advertisement. Generating the targeted advertisement may also include identifying a target audience for the advertisement. As disclosed herein, consumer data 104 may be used to identify consumers that may be located near a business during the time period of expected decrease traffic. Consumer data 104 may also be used to identify customers that may be located within a predetermined distance of a location, such as the business, during the time of expected decreased traffic. For instance, consumer data 104 may include calendar information for customers. The calendar information may include locations where customers may be located at future times, which may correspond to the time period of expected decreased traffic.

Once the targeted advertisement has been generated, the target advertisement may be deployed (308). For example, once the advertisement, such as advertisement 102, is approved, such as via button 110, computing device 200 may transmit the advertisement to customers identified while generating the advertisement.

After the advertisement has been deployed, updated customer data may be received (310). The updated customer data may include updates on the business owner's sales, updated information from other business related to sales during the time period of expected decreased traffic, etc. The updated customer data can be used evaluate the effectiveness of the advertisement campaign.

Using the updated consumer data, the user can change the incentive (312). For instance, depending on the effectiveness of the advertisement campaign, the user may increase or decrease the incentive included in the advertisement. As disclosed herein, if traffic at the user's business does not increase as expected, the user can increase the value ofthe incentive in an attempt to draw more customers. If the traffic at the user's business is greater than expected, the user can decrease the value of the incentive to increase the ROI of the advertisement campaign in the future.

FIG. 3 shows that once the incentive is changed, method 300 may return to stage 308 where the targeted advertisement may be deployed. Method 300 may return to any one of stages 302, 304, or 306. For example, based on the updated consumer data received in stage 312, a new time period for decreased traffic may be identified. The user may establish a new budget and/or generate a new advertisement based on the updated consumer/traffic data.

Also, while the stages of method 300 may be shown in a particular order, the stages may be performed in other orders and stages may be omitted. For example, a party offering the targeted advertisement service may set a price for targeted advertisements and thus, stage 304 may be omitted. Other permutations of the stages of method 300 are contemplated and within the scope of this disclosure.

### EXAMPLES

Example 1 is a method for deploying a targeted advertisement, the method comprising: identifying a time period of expected decreased traffic; generating the targeted advertisement based on constraints set by a user; and deploying the targeted advertisement during a predetermined time period prior to the time period of expected decreased traffic.

In Example 2, the subject matter of Example 1 optionally includes establishing a budget for the targeted advertisement.

In Example 3, the subject matter of any one or more of Examples 1-2 optionally include wherein generating the targeted advertisement includes identifying a target audience for the targeted advertisement.

In Example 4, the subject matter of any one or more of Examples 1-3 optionally include wherein generating the targeted advertisement includes generating an incentive to be included in the targeted advertisement.

In Example 5, the subject matter of any one or more of Examples 1-4 optionally include receiving updated traffic data corresponding to the time period of expected decreased traffic.

In Example 6, the subject matter of Example 5 optionally includes increasing an incentive included in the targeted advertisement based on the updated traffic data received.

In Example 7, the subject matter of any one or more of Examples 1-6 optionally include wherein deploying the targeted advertisement includes transmitting the targeting advertisement to mobile devices located within a predetermined distance of a location.

Example 8 is a system for deploying a targeted advertisement, the system comprising: a processor; and a memory storing instructions that, when executed by the processor, cause the processor to perform actions comprising: identifying a time period of expected decreased traffic, generating, based on input received from a mobile device, the targeted advertisement based on constraints set by a user, and deploying the targeted advertisement during a predetermined time period prior to the time period of expected decreased traffic.

In Example 9, the subject matter of Example 8 optionally includes wherein the actions further comprise receiving, from the mobile device, a budget for the targeted advertisement.

In Example 10, the subject matter of any one or more of Examples 8-9 optionally include wherein generating the targeted advertisement includes identifying a target audience for the targeted advertisement.

In Example 11, the subject matter of any one or more of Examples 8-10 optionally include wherein generating the targeted advertisement includes generating an incentive to be included in the targeted advertisement.

In Example 12, the subject matter of any one or more of Examples 8-11 optionally include wherein the actions further comprise receiving updated traffic data corresponding to the time period of expected decreased traffic.

In Example 13, the subject matter of Example 12 optionally includes wherein the actions further comprise increasing an incentive included in the targeted advertisement based on the updated traffic data received.

In Example 14, the subject matter of any one or more of Examples 8-13 optionally include wherein deploying the targeted advertisement includes transmitting the targeting advertisement to mobile devices located within a predetermined distance of a location.

Example 15 is a system for deploying a targeted advertisement, the system comprising: a processor in electrical communication with the display; and a memory storing instructions that, when executed by the processor, cause the processor to perform actions comprising: receiving constraints from a user, the constraints include a budget, identifying a time period of expected decreased traffic corresponding to an event, generating, based on input received from a mobile device, the targeted advertisement based on the constraints, and deploying the targeted advertisement during a predetermined time period prior to the time period of expected decreased traffic.

In Example 16, the subject matter of Example 15 optionally includes wherein generating the targeted advertisement includes identifying a target audience for the targeted advertisement, the target audience attending the event.

In Example 17, the subject matter of any one or more of Examples 15-16 optionally include wherein generating the targeted advertisement includes generating an incentive to be included in the targeted advertisement.

In Example 18, the subject matter of any one or more of Examples 15-17 optionally include wherein the actions further comprise: receiving updated traffic data corresponding to the time period of expected decreased traffic; and increasing an incentive included in the targeted advertisement based on the updated traffic data received.

In Example 19, the subject matter of any one or more of Examples 15-18 optionally include wherein deploying the targeted advertisement includes transmitting the targeting advertisement to mobile devices located within a predetermined distance of the event.

In Example 20, the subject matter of any one or more of Examples 15-19 optionally include wherein the event includes one of a concert or sporting event.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

1. A method for deploying a targeted advertisement, the method comprising:
identifying a time period of expected decreased traffic;
generating the targeted advertisement based on constraints set by a user; and
deploying the targeted advertisement during a predetermined time period prior to the time period of expected decreased traffic.

2. The method of claim 1, further comprising establishing a budget for the targeted advertisement.

3. The method of claim 1, wherein generating the targeted advertisement includes identifying a target audience for the targeted advertisement.

4. The method of claim 1, wherein generating the targeted advertisement includes generating an incentive to be included in the targeted advertisement.

5. The method of claim 1, further comprising receiving updated traffic data corresponding to the time period of expected decreased traffic.

6. The method of claim 5, further comprising increasing an incentive included in the targeted advertisement based on the updated traffic data received.

7. The method of claim 1, wherein deploying the targeted advertisement includes transmitting the targeting advertisement to mobile devices located within a predetermined distance of a location.

8. A system for deploying a targeted advertisement, the system comprising:
a processor; and
a memory storing instructions that, when executed by the processor, cause the processor to perform actions comprising:
identifying a time period of expected decreased traffic,
generating, based on input received from a mobile device, the targeted advertisement based on constraints set by a user, and
deploying the targeted advertisement during a predetermined time period prior to the time period of expected decreased traffic.

9. The system of claim 8, wherein the actions further comprise receiving, from the mobile device, a budget for the targeted advertisement.

10. The system of claim 8, wherein generating the targeted advertisement includes identifying a target audience for the targeted advertisement.

11. The system of claim 8, wherein generating the targeted advertisement includes generating an incentive to be included in the targeted advertisement.

12. The system of claim 8, wherein the actions further comprise receiving updated traffic data corresponding to the time period of expected decreased traffic.

13. The system of claim 12, wherein the actions further comprise increasing an incentive included in the targeted advertisement based on the updated traffic data received.

14. The system of claim 8, wherein deploying the targeted advertisement includes transmitting the targeting advertisement to mobile devices located within a predetermined distance of a location.

15. A system for deploying a targeted advertisement, the system comprising:
a processor in electrical communication with the display; and
a memory storing instructions that, when executed by the processor, cause the processor to perform actions comprising:
receiving constraints from a user, the constraints include a budget,
identifying a time period of expected decreased traffic corresponding to an event,
generating, based on input received from a mobile device, the targeted advertisement based on the constraints, and
deploying the targeted advertisement during a predetermined time period prior to the time period of expected decreased traffic.

16. The system of claim 15, wherein generating the targeted advertisement includes identifying a target audience for the targeted advertisement, the target audience attending the event.

17. The system of claim 15, wherein generating the targeted advertisement includes generating an incentive to be included in the targeted advertisement.

18. The system of claim 15, wherein the actions further comprise:
receiving updated traffic data corresponding to the time period of expected decreased traffic; and
increasing an incentive included in the targeted advertisement based on the updated traffic data received.

19. The system of claim 15, wherein deploying the targeted advertisement includes transmitting the targeting advertisement to mobile devices located within a predetermined distance of the event.

20. The system of claim 15, wherein the event includes one of a concert or sporting event.
